(19) United States
(12) Patent Application Publication
(10) Pub. No.: US 2009/0255623 A1
(43) Pub. Date: Oct. 15, 2009

(54) APPARATUS AND METHODS FOR APPLYING ADHESIVE TO LABELS

(75) Inventors: Jorg-Olaf Bagung, Deutsch Evern (DE); Olivier Huss, Cumming, GA (US); Hubert Kufner, Luneburg (DE)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 12/103,374

(22) Filed: Apr. 15, 2008

(51) Int. Cl. B32B 37/12; B05C 9/00; B05D 5/10

(52) U.S. Cl. 156/230; 118/209; 118/244; 118/230; 427/256

(57) ABSTRACT

An apparatus for applying adhesive to labels includes an adhesive transfer device having an adhesive receiving surface that receives adhesive from an adhesive applicator at a first location and moves the adhesive to a second location proximate a label supporting device for transferring the adhesive to a label supported on the label supporting device. In one embodiment, the adhesive transfer device may be adapted to receive labels from the label supporting device and to carry the labels to a third location for transfer of the labels to respective containers.

### TECHNICAL FIELD

The present invention relates generally to the application of adhesive to substrates, and more particularly to the application of adhesive to labels.

### BACKGROUND

Labels may be made in various sizes and shapes, and may be one of several types. One type of label, for example, is the wrap-around label, in which a leading edge of the label is initially secured with adhesive to a three dimensional object, such as a container or other product or product packaging of any shape. The label is then wrapped around the object so that the trailing edge of the label overlaps and is adhesively secured to itself. Another type of label is one in which both the leading and trailing edges of the label are affixed directly to the object.

The securement of labels to bottles or other containers, for example, must be of such a quality that the labels can withstand the various conditions that may be later experienced by the containers or bottles during shipping, storage, and use thereof, subsequent to the product packaging or filling operation. For example, labels that are applied to bottles of carbonated beverages must withstand expansion of the bottles due to the carbonation of the beverage, and additional expansion and contraction during shipping and storage operations in which the temperatures of the product may vary. Moreover, the labels must also be aesthetically pleasing. For example, it may be desired that the exposed edge of a label does not readily flap loosely away from the product, become detached from the product, have exposed adhesive, or have large amounts of adhesive forming lumps underneath the label.

In conventional processes, adhesive is applied to labels using a wheel coater. Wheel coaters typically use an open reservoir for holding the adhesive. A rotating wheel receives a coating of adhesive on its outer circumference and then transfers the adhesive onto a label by rolling contact with the label. A container, such as a bottle, can, or other type of object moves along a conveyor and a paper or plastic label is secured to the outer surface of the container or object during a production operation. One drawback of wheel-applied adhesive is that the open reservoir is susceptible to contamination, which may affect the quality of applied labels.

Many conventional labeling apparatus include vacuum drums for carrying past an adhesive application station and for transferring the adhesive-coated labels to respective containers. One drawback of such systems is that excess adhesive, in the form of fly-away or stringing adhesive, for example, may be inadvertently drawn into the vacuum drum. Excess adhesive may also be inadvertently caught on a label, thereby adversely affecting the aesthetic appearance of the label.

There is a need for apparatus and methods of applying adhesive to labels that overcome these and other drawbacks of conventional adhesive application devices.

### SUMMARY

The present invention overcomes the foregoing and other shortcomings and drawbacks of methods and apparatus heretofore known for applying adhesive to labels. While the invention will be described in connection with certain embodiments, it will be understood that the invention is not limited to these embodiments. On the contrary, the invention includes all alternatives, modifications and equivalents as may be included within the spirit and scope of the present invention.

In one aspect, an apparatus for applying adhesive to labels includes an adhesive transfer device having an adhesive receiving surface that is movable along a continuous path between a first location and a second location. An adhesive applicator proximate the adhesive transfer device is able to contact the adhesive receiving surface at the first location to dispense adhesive to the adhesive receiving surface. A label supporting device is located proximate the second location, and the adhesive transfer device moves the adhesive to the second location and applies the adhesive to a label supported on the label supporting device. The adhesive applicator may be intermittently actuatable to facilitate applying adhesive in a desired pattern to the label.

In one embodiment, the adhesive transfer device may comprise a rotatable belt. In another embodiment, the adhesive transfer device may comprise a transfer roller. In yet another embodiment, the label supporting device may comprise a rotatable drum having an outer surface that supports labels thereon. After adhesive has been applied to the labels on the drum, the drum transfers the adhesive-coated labels to respective containers.

In another embodiment, the label supporting device may be adapted to receive labels from a roll and to separate the labels into discrete items. In one aspect, the adhesive transfer device may be a rotatable belt adapted to receive labels from the label supporting device and to carry the labels to a location for transferring the labels to respective containers.

In yet another embodiment, a method of applying adhesive to labels includes applying adhesive to an adhesive transfer device at a first location, moving the adhesive from the first location to a second location using the adhesive transfer device, and contacting a label with the adhesive on the adhesive transfer device to thereby transfer the adhesive to the label. The method may further include receiving the label on the adhesive transfer device, moving the label to a third location with the adhesive transfer device, and transferring the label to a container at the third location.

These and other features, objects and advantages of the invention will become more readily apparent to those skilled in the art in view of the following detailed description, taken in conjunction with the accompanying drawings.

### BRIEF DESCRIPTION OF THE DRAWINGS

The accompanying drawings, which are incorporated in and constitute a part of this specification, illustrate embodiments of the invention and, together with the general description of the invention given above, and the detailed description given below, serve to explain the principles of the invention.

FIG. 1 is a schematic plan view of an exemplary labeling apparatus in accordance with the principles of the present disclosure.

FIG. 2 is a schematic plan view of a second exemplary labeling apparatus in accordance with the principles of the present disclosure.

FIG. 3 is a schematic plan view of a third embodiment of a labeling apparatus in accordance with the principles of the present disclosure.

### DETAILED DESCRIPTION

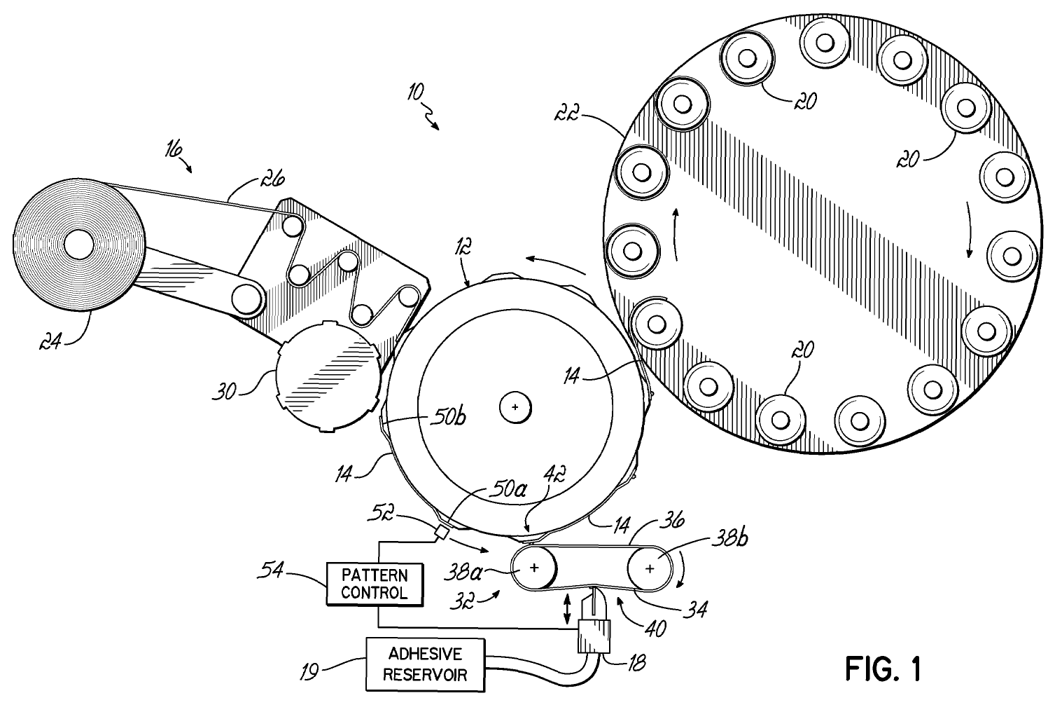

FIG. 1 depicts an exemplary labeling apparatus 10 in accordance with the principles of the present disclosure. The labeling apparatus 10 includes a vacuum drum 12 for receiving labels 14 from a label feed device 16, moving the labels 14 past an adhesive applicator 18, and applying the labels 14 to containers 20 moving past the vacuum drum 12 on a conveyor 22. In the embodiment shown, the label feed device 16 is adapted to receive labels 14 from a roll 24 and to direct the labels 14 to the outer circumferential surface of the vacuum drum 12. The labels 14 may be carried by the vacuum drum 12 as a continuous web 26, or the labels 14 may be cut from the web 26 while on the vacuum drum 12, or prior to being transferred to the vacuum drum 12. In the embodiment shown, a label cutting drum 30 is provided adjacent the label feed device 16 and the vacuum drum 12 for cutting discreet labels 14 from the web 26. It will be appreciated, however, that various other methods or devices for cutting individual labels 14 from a roll 24 may be used.

The label feed device 16 may include capstans and/or drive rollers to direct the labels 14 from the roll 24 to the surface of the vacuum drum 12. While the label feed device 16 has been shown and described herein as being adapted to receive and deliver labels 14 to the vacuum drum 12 from a roll 24, it will be appreciated that various other label feed devices may be alternatively be used. For example, an alternative label feed device (not shown) may include a magazine for feeding a stack of pre-cut labels 14 to the vacuum drum 12.

With continued reference to FIG. 1, the labeling apparatus 10 further includes an adhesive transfer device 32 for receiving adhesive from the adhesive applicator 18 and transferring the adhesive to labels 14 supported on the vacuum drum 12. The adhesive transfer device 32 reduces or eliminates extraneous adhesive that may inadvertently be deposited on a label 14 or get drawn into the vacuum drum 12. In the embodiment shown, the adhesive transfer device 32 comprises a rotatable belt 34. An outer surface of the belt 34 serves as the adhesive receiving surface 36 and is moved along a generally continuous path by rollers or pulleys 38a, 38b that support the belt 34. The belt 34 moves along the generally continuous path between a first location 40 where adhesive is applied to the adhesive receiving surface 36 of the belt 34 by the adhesive applicator 18, and a second location 42 proximate the vacuum drum 12 where the adhesive receiving surface 36 of the belt 34 engages the vacuum drum 12 to transfer the adhesive to a label 14 supported on the outer surface of the vacuum drum 12.

In the embodiment shown, the adhesive applicator 18 is a slot nozzle adhesive applicator that contacts the adhesive receiving surface 36 of the belt 34, such as a PatternCoat™ slot gun, available from Nordson Corporation of Westlake, Ohio. Adhesive may be supplied to the adhesive applicator 18 from an adhesive reservoir 19. It will be appreciated that various other types of adhesive applicators 18 may be used to apply adhesive to the adhesive receiving surface 36 of the belt 34, including various contact and non-contact types of adhesive applicators. The adhesive applicator 18 may be controlled for intermittent actuation of the adhesive, whereby adhesive can be selectively applied to the adhesive receiving surface 36 of the belt 34 for subsequent transfer to selected portions of a label 14. Accordingly, the adhesive may be applied to one or more portions of a label 14 as a continuous coating or in a desired pattern. As used herein, application of adhesive in a pattern means that adhesive is applied in a configuration other than a continuous coating. As non-limiting examples, such patterns may include arrangements of lines or beads, dots, swirls, or various other configurations of dispensed adhesive.

As the adhesive receiving surface 36 of the belt 34 engages the vacuum drum 12 proximate the second location 42, adhesive may be transferred from the adhesive receiving surface 36 of the belt 34 to a label 14 supported on the vacuum drum 12. Accordingly, the belt 34 rotates at a speed synchronized with the speed of the vacuum drum 12 so that adhesive is transferred to a leading edge 50a and/or a trailing edge 50b of a label 14, or to various other desired portions of the label 14. As the vacuum drum 12 continues to rotate it carries the adhesive-coated labels 14 for contact with containers 20 moving past the vacuum drum 12 on the conveyor 22. As the adhesive-coated labels 14 contact the containers 20, the labels 14 are transferred from the vacuum drum 12 to the containers 20.

The labeling apparatus 10 may further include one or more sensors 52 positioned adjacent the vacuum drum 12 for sensing locations associated with the leading and trailing edges 50a, 50b of labels 14 carried on the vacuum drum 12 to facilitate synchronizing the placement of adhesive on the belt 34 and the rotating speed of the belt 34 relative to the rotating speed of the vacuum drum 12, to ensure that adhesive is transferred to appropriate locations of the labels 14 carried on the vacuum drum 12. The sensor 52 may be configured to directly sense the leading edges 50a and/or trailing edges 50b of the labels 14, or may be configured to sense a portion of the vacuum drum 12 corresponding to a location of the leading and/or trailing edges 50a, 50b of labels 14. The labeling apparatus 10 may further include a pattern control 54 communicating with the sensor 52 and the adhesive applicator 18 to ensure proper transfer of adhesive to desired portions of the labels 14.

The adhesive applicator 18 may be biased in a direction toward the belt 34. This may be desired, for example, to ensure sufficient contact with the belt 34, such as when the adhesive applicator 18 is a slot nozzle type applicator. Moreover, the adhesive applicator 18 and/or the belt 34 may be movable in directions toward and away from the vacuum drum 12, whereby the adhesive transfer device 32 may be spaced from the vacuum drum 12. This may be desired, for example, when the vacuum drum 12 is not being used to apply labels 14 to containers 20.

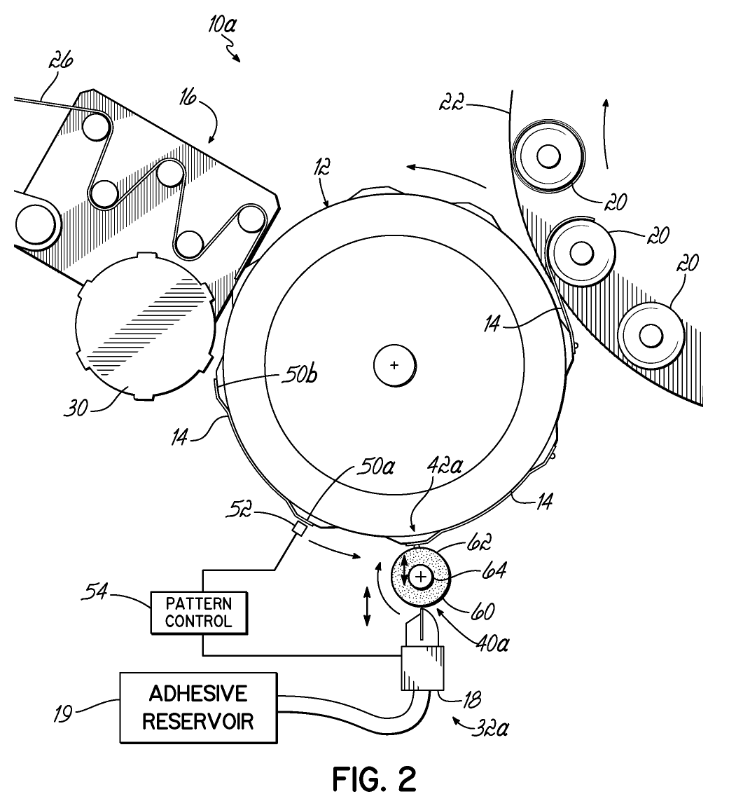

FIG. 2 depicts another exemplary labeling apparatus 10a, similar to the labeling apparatus 10 discussed above with respect to FIG. 1, but wherein the adhesive transfer device 32a comprises a transfer roller 60. Operation of the labeling apparatus 10a is similar to that described above for labeling apparatus 10, and features of the labeling apparatus 10a that are similar to features depicted in FIG. 1 have been similarly numbered. In this embodiment, the outer surface of the transfer roller 60 serves as the adhesive receiving surface 62 and is moved along a generally continuous path between the first location 40a for receiving adhesive from the adhesive applicator 18, and the second location 42a for transferring adhesive to the vacuum drum 12, by rotation of the transfer roller 60 about its rotational axis 64. The transfer roller 60 and/or the adhesive applicator 18 are movable in directions toward and away from the vacuum drum 12, which may be desired, for example, when the vacuum drum 12 is not being used to apply labels 14 to containers 20.

The labeling apparatus 10a may further include one or more sensors 52 positioned adjacent the vacuum drum 12 for sensing locations associated with the leading and trailing edges 50a, 50b of labels 14 carried on the vacuum drum 12. Sensor 52 facilitates synchronizing the placement of adhesive on the transfer roller 60 and synchronizing the rotating speed of the transfer roller 60 relative to the rotating speed of the vacuum drum 12, to ensure that adhesive is transferred to appropriate locations of the labels 14 carried on the vacuum drum 12. The sensor 52 may be configured to directly sense the leading edges 50a and/or trailing edges 50b of the labels 14, or may be configured to sense a portion of the vacuum drum 12 corresponding to a location of the leading and/or trailing edges 50a, 50b of labels 14. The labeling apparatus 10a may further include a pattern control 54 communicating with the sensor 52 and the adhesive applicator 18 to ensure proper transfer of adhesive to desired portions of the labels 14.

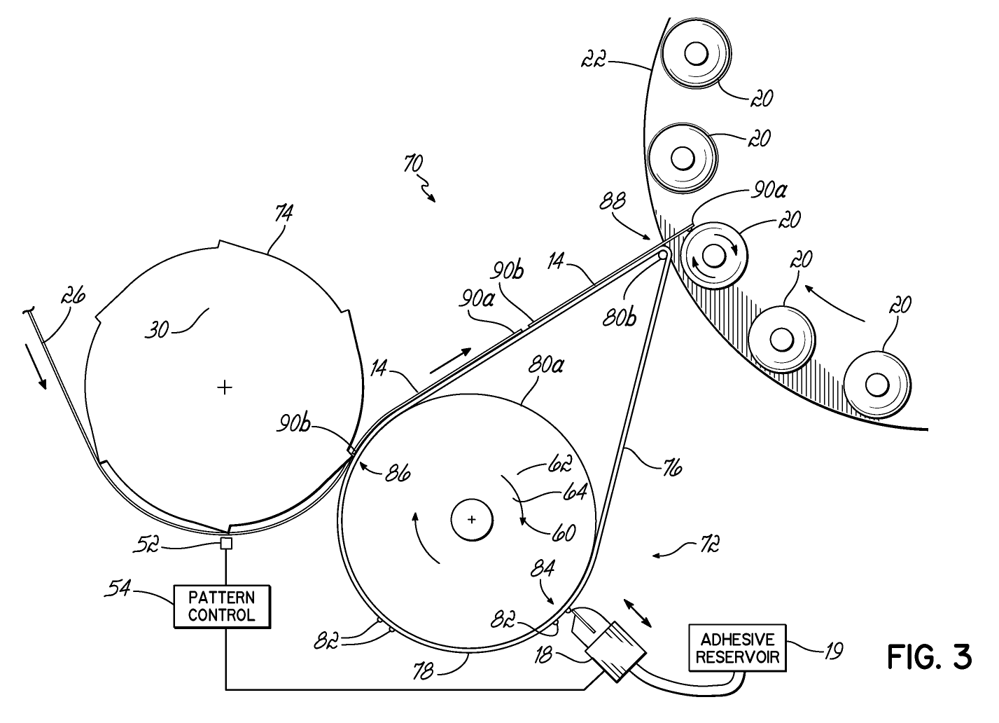

FIG. 3 depicts another exemplary labeling apparatus 70 which does not include a vacuum drum for receiving labels from a feed device and transferring them to containers on a conveyor. Instead, the labels 14 are carried by and transferred to the containers 20 by the adhesive transfer device 72. In this embodiment, a continuous web 26 of labels 14 is received from a roll onto a cutting drum 74. The cutting drum 74 separates the continuous web 26 into discreet labels 14 and directs the labels 14 for contact with the adhesive transfer device 72. The adhesive transfer device 72 comprises a rotatable belt 76 having an outer adhesive receiving surface 78 that is moved along a generally continuous path by first and second rollers 80a, 80b. Adhesive 82 is applied to the adhesive receiving surface 78 of the belt 76 at a first location 84 by an adhesive applicator 18. The adhesive 82 is carried by the belt 76 toward a second location 86 proximate the cutting drum 74 where the adhesive 82 is brought into contact with the labels 14 separated by the cutting drum 74. As the adhesive 82 contacts the labels 14, the labels 14 are transferred to the adhesive receiving surface 78 of the belt 76 and are carried by the belt 76 toward a third location 88 where the labels 14 are transferred from the belt 76 to containers 20 moving past the belt 76 on the conveyor 22. To facilitate transferring the labels 14 from the belt 76 to the containers 20, the belt 76 includes a sharp turn radius at the third location 88 which causes the leading edges 90 of the labels 14 to project from the adhesive receiving surface 78 of the belt 76 for contact with containers 20 moving past the third location 88. As the containers 20 are rotated along the conveyor 22, the labels 14 are wound upon the containers 20.

The labeling apparatus 70 may further include a sensor 52 positioned to detect the leading edges 90a and/or trailing edges 90b of labels 14 cut from the web 26 of label material, and a pattern control 54 communicating with the sensor 52 and the adhesive applicator 18 to facilitate the application of adhesive 82 to the adhesive receiving surface 78 of the belt 76 for transfer to appropriate locations of the labels 14, in a manner similar to that discussed above. The adhesive applicator 18 may also be movable in directions toward and away from the adhesive transfer device 72, in a manner similar to that discussed above.

While the present invention has been illustrated by the description of one or more embodiments thereof, and while the embodiments have been described in considerable detail, they are not intended to restrict or in any way limit the scope of the appended claims to such detail. The various features described herein may be used alone or in any combination. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

What is claimed is:

1. An apparatus for applying adhesive to labels, comprising:
an adhesive transfer device having an adhesive receiving surface movable along a continuous path between a first location and a second location;
an intermittently actuatable adhesive applicator proximate said adhesive transfer device and capable of contacting said adhesive receiving surface at said first location to dispense adhesive to said adhesive receiving surface in a desired pattern; and
a label supporting device proximate said second location, said label supporting device including a label support surface adapted to support one or more labels thereon;
said adhesive receiving surface engaging said label support surface at said second location to thereby apply adhesive to a label supported on said label support surface.

2. The apparatus of claim 1, wherein said adhesive applicator is adapted to apply adhesive to portions of the label proximate leading and trailing edges of the label, but not to at least a portion of the label between the leading and trailing edges.

3. The apparatus of claim 1, wherein said adhesive applicator is adapted to apply adhesive only to portions of the label proximate a trailing edge of the label.

4. The apparatus of claim 1, wherein said label supporting device comprises a rotatable drum and said label support surface is an outer surface of said drum, said outer surface further adapted to transfer adhesive coated labels from said outer surface to respective containers.

5. The apparatus of claim 4, wherein said adhesive transfer device comprises a rotatable belt.

6. The apparatus of claim 5, wherein said adhesive applicator is biased in a direction toward said adhesive receiving surface of said belt.

7. The apparatus of claim 4, wherein said adhesive transfer device comprises a transfer roller.

8. The apparatus of claim 4, further comprising:
a sensor proximate said drum and adapted to sense a location associated with a label supported on said drum.

9. The apparatus of claim 8, wherein said sensor is adapted to sense a leading edge of the label, a trailing edge of the label, or both the leading and the trailing edges of the label.

10. The apparatus of claim 8, wherein said sensor is adapted to sense portions of said drum corresponding to leading and trailing edges of labels supported on said outer surface of said drum.

11. The apparatus of claim 1, wherein said label supporting device is adapted to receive labels from a roll and to separate the labels into discrete items.

12. The apparatus of claim 11, wherein said adhesive transfer device comprises a rotatable belt.

13. The apparatus of claim 12, wherein said rotatable belt is adapted to receive the labels from said label supporting device during contact with said label supporting device at said second location;
said rotatable belt adapted to carry the adhesive coated labels to a third location for transfer of the labels to respective containers.

14. The apparatus of claim 13, wherein said rotatable belt includes a sharp turn radius proximate said third location to facilitate transfer of the labels to the containers.

15. The apparatus of claim 1, wherein said adhesive applicator is a slot nozzle adhesive applicator.

16. A method of applying adhesive to labels, the method comprising:
intermittently applying adhesive to an adhesive transfer device at a first location;
moving the adhesive from the first location to a second location using the adhesive transfer device; and
contacting a label at the second location with the adhesive on the adhesive transfer device to thereby transfer the adhesive to the label.

17. The method of claim 16, further comprising:
biasing an adhesive applicator in a direction toward the adhesive transfer device.

18. The method of claim 16, further comprising:
receiving the label on the adhesive transfer device;
moving the label with the adhesive transfer device to a third location proximate a container for receiving the label; and
transferring the label to the container from the adhesive transfer device.

19. The method of claim 16, wherein intermittently applying adhesive to the adhesive transfer device comprises applying the adhesive in a pattern.

20. The method of claim 16, wherein intermittently applying adhesive to the adhesive transfer device comprises applying adhesive such that the adhesive will be transferred to the label proximate leading and trailing edge portions of the label, but not to at least a portion of the label between the leading and trailing edges.

21. The method of claim 16, wherein intermittently applying adhesive to the adhesive transfer device comprises applying adhesive such that the adhesive will be transferred to the label only proximate a trailing edge portion of the label.
